(19) United States
(12) Patent Application Publication
(10) Pub. No.: US 2005/0191045 A1
(43) Pub. Date: Sep. 1, 2005

(54) Photographic camera

(75) Inventor: Kenji Yamane, Saitama-Shi (JP)

Correspondence Address: YOUNG & THOMPSON, 745 SOUTH 23RD STREET, 2ND FLOOR, ARLINGTON, VA, 22202, US

(73) Assignee: FUJINON CORPORATION, SAITAMA-SHI (JP)

(21) Appl. No.: 11/020,140

(22) Filed: Dec. 27, 2004

(30) Foreign Application Priority Data
Dec. 25, 2003 (JP) 2003-429272

(51) Int. Cl. G03B 17/02

(52) U.S. Cl. 396/6

(57) ABSTRACT

A photographic camera for drawing out a film from a film cartridge loaded therein and winding up the film around a cylindrical take-up spool comprises a film hold-down mechanism installed to the back cover and disposed in a passageway of the film so as to hold down the film toward the take-up spool at a position before a generating line of the cylindrical take-up spool closest to the back cover when the back cover is closed. When the back cover is fully closed and locked, the camera automatically actuates a built-in motor to rotate the take-up spool to wind reliably the film around the take-up spool.

### BACKGROUND OF THE INVENTION

1. Field of the Invention

The present invention relates to a photographic camera featured in simplified film loading.

2. Description of Related Art

Typically, recent photographic cameras are designed to load the camera with a film without engaging a leading end of a film with a take-up spool of the camera. In loading such a photographic camera with a roll of film, it is sufficient for film loading to place a film cartridge with a film partly pre-drawn out of the film cartridge in the film chamber after opening the back cover, pull the film across the back of the camera until its tip is put on a take-up spool within a film winding chamber, then close the back cover. When the back cover is closed, the camera automatically rotates the take-up spool to bring circumferential catching claws of the take-up spool in engagement with perforations of the film and winds the film on the take-up spool. The camera continuously rotates the take-up spool to advances the film and stop to complete preparatory-winding when the film is advanced to its starting position in which a first unexposed frame of the film is located right behind an exposure aperture of the camera. The preparatory-winding is controlled by counting the number of perforations with a photoelectric sensor. Some cameras have a take-up spool covered with a high-frictional rubber sheath or a take-up spool without circumferential catching claws for facility of preparatory-winding of the film on the take-up spool.

Further, for reliable winding, some cameras including automatic film loading and wind on feature have been improved so as to hold down the film against the outer surface of the take-up spool by a roller or a leaf spring either in the film winding chamber or on an inner surface of the back cover when the back cover is closed or so as to prevent the film from lifting from the take-up spool while the film is wound around the take-up spool for a first turn, such as disclosed in, for example, Japanese Unexamined Patent Publication Nos. 8-254745 and 9-203968.

Such an improved automatic film loading camera winds on a film reliably around the take-up spool if a film leader has an appropriate pre-drawn length. That is, as shown by way of example in FIG. 8, when a film 3 has been partly pre-drawn out by an appropriately sufficient length as shown by a chain double-dashed line, a leaf spring 2a attached to the back cover 2 holds down the film 3 against the take-up spool 4 so as thereby to drag it out with frictional force between the take-up spool 4 and bring perforations of the film 3 into engagement with the circumferential catching claws 4a of the take-up spool 4 due to rotation of the take-up spool 4. As a result, the camera continues to wind the film reliably on the take-up spool 4. However, if the film 3 is too short in pre-drawn length, it is possibly unable to reach a ridge line of the take-up spool 4 (a generating line of the take-up spool 4 closest to the back cover 2) when the back cover 2 is closed. In this instance, although the film should be drawn out of the film cartridge a little more, photographers who are unaccustomed to handling the camera not infrequently close the back cover 2 without drawing the film 3. In this event, only the leading end 3a of the film 3 hits the take-up spool 4 short of the ridge line of the take-up spool 4 due to the behavior of curing inward of the film as shown in FIG. 8. If trying to wind on the film in this condition of the film, the circumferential catching claws 4a of the take-up spool 4 pass by the leading end 3a of the film 3 without engaging with the perforations of the film 3, possibly ending in failure in winding on the film. Further, even in the case of employing the take-up spool 4 covered with a high-frictional rubber sheath, film winding is not always smoothly achieved if the leading end 3a of the film 3 is firmly pinched between the leaf spring 2a and the take-up spool 4.

### SUMMARY OF THE INVENTION

It is therefore an object of the present invention to provide a photographic camera that enables winding a film on a take-up spool even in an event where a film cartridge with a film insufficiently pre-drawn out of the film cartridge is loaded.

The foregoing object is accomplished by a photographic camera for drawing out a film from a film cartridge loaded therein and winding up the film around a take-up spool, comprising film hold-down means disposed in a passageway of the film for holding down the film toward the take-up spool at a position before a generating line of the cylindrical core of the take-up spool closest to a back cover of the camera when the back cover is closed. The cylindrical core of the take-up spool is desirably provided with circumferential claws extending from a periphery of the cylindrical core so as to be capable of engaging with perforations of the film. Further, the film hold-down means desirably comprises a film hold-down lever pivotally mounted to the back cover and urged toward the take-up spool so as to hold down the film toward the take-up spool and a film detection lever mounted to the camera body so as to detect the film with the perforations in engagement with the circumferential claw. The film detection lever keeps the film hold-down lever from holding down the film when detecting the film being wound around the cylindrical core of the take-up spool.

According to the photographic camera of the present invention, even in the event a film partly pre-drawn out of a film cartridge is too short to put its leading end on the take-up spool, the film is successfully wound around the take-up spool only by closing the back cover accompanying actuation of a built-in drive motor. In the case of using the take-up spool provided with the circumferential claws, the photographic camera makes certain of engagement between the circumferential claws and perforations of a film, achieving simple and reliable film loading.

Furthermore, when the film detection lever 24 detects advancement of film winding assured through engagement between the circumferential claws and the film perforations, it forces the film hold-down lever to draw away from the film, so as thereby to reduce a winding load on the film winding mechanism and, in consequence, to prevent the film from being rubbed with the film hold-down lever.

### BRIEF DESCRIPTION OF TH DRAWINGS

The foregoing and other objects and features of the present invention will be clearly understood from the following detailed description when reading with reference to the accompanying drawings, wherein the same reference signs have been used to denote same or similar parts throughout the drawings, and in which:

FIG. 1 is a perspective view of a photographic camera having an autowinding feature according to an embodiment of the present invention;

FIG. 2 is a rear view of the photographic camera;

FIG. 3 is a perspective view of a film hold-down mechanism including a film detection lever and a film hold-down lever of the photographic camera;

FIG. 4 is a perspective view of details of the film hold-down mechanism;

FIGS. 5A and 5B are sectional views showing operation of the film hold-down mechanism at the beginning of winding a film;

FIGS. 6A and 6B are sectional views showing operation of the film hold-down mechanism for engagement of perforations of a film and claws of a take-up spool;

FIG. 7 is a perspective view of a film hold-down mechanism according to another embodiment of the present invention; and

FIG. 8 is a sectional view of an interior of a prior art photographic camera.

### DETAILED DESCRIPTION OF THE PREFERRED EMBODIMENTS

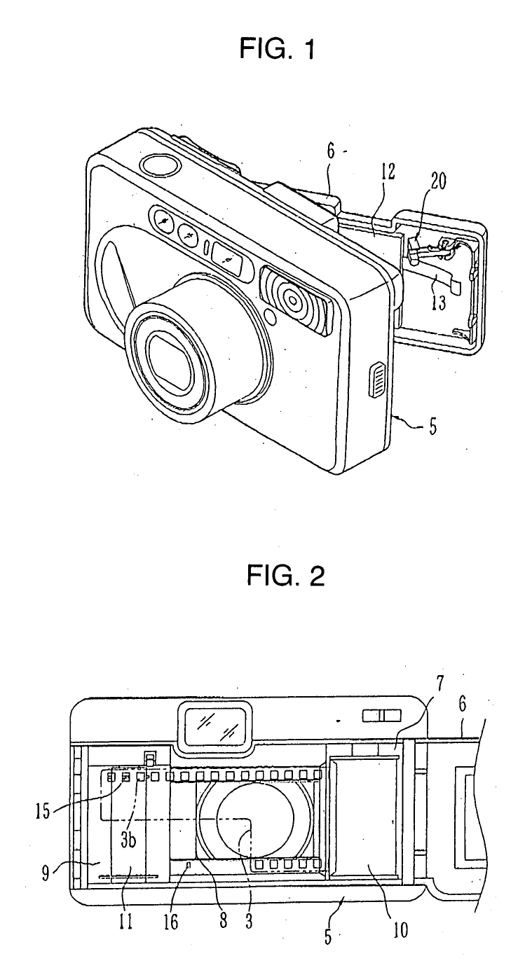

Referring to the accompanying drawings in detail, and in particular, to FIGS. 1 and 2 showing a photographic camera according to an embodiment of the present invention, the camera 5 has a camera body 5a made up of a plastic injection molded product and is provided with a back cover 6 pivotally mounted to the camera body 5a. The camera body 5a includes a film chamber 7 in which a film cartridge 10 is put, an exposure aperture 8 and a film winding chamber 9 having a take-up spool 11 with circumferential catching claws 15 arranged at regular angular intervals on which an exposed film is wound up. These chambers and aperture are all exposed when opening the back cover 6 as shown in FIG. 2. Film loading is achieved by placing the film cartridge 10 with a leading portion of the film 3 pre-drawn out of the film cartridge 10 as depicted by a chain double-dashed line into the film chamber 7 after opening the back cover 6, pulling the film 3 across the back of the camera body 5a until its leading end 3a is put on the take-up spool 11 within the film winding chamber 9, and then closing the back cover 6.

As shown in FIG. 1, the camera body 5a is provided with a pressure plate 12 attached to the back cover 6 right behind the exposure aperture 8 through a leaf spring (not shown) and a reflective photoelectric sensor 16 located within a passageway of perforations 3b of the film 3 so as to detect the perforations 3b of the film 3. The pressure plate 12 at one of its opposite sides is provided with a pressure leaf spring 13 so that the pressure leaf spring 13 at its distal end bears down the leading end 3a of the film 3 on the take-up spool 11 when closing the back cover 6. When the back cover 6 is closed and locked, the camera 5 automatically actuates a build-in reversible drive motor (not shown) in a normal direction to rotate the take-up spool 11 so as to bring circumferential catching claws 15 of the take-up spool 11 into engagement with perforations 3b of the film 3, thereby winding the film 3 around the take-up spool 11. When the photoelectric sensor 16 detects a predetermined number of perforations 3b, the drive motor is automatically stopped to locate a first unexposed frame of the film 3 right behind the exposure aperture 8, thereby putting the camera 5 ready for a shot. The camera 5 has a film rewind mechanism for automatically rewind the film 3 into the film cartridge 10 immediately after all frames of the film 3 are exposed. The film rewind mechanism includes a rotatable fork that is connected to the drive motor and coupled to a spool of the film cartridge 10. The film rewind mechanism is known in various types and may take any type well known in the art.

In order that the camera 5 is enabled to wind the film 3 smoothly around the take-up spool 11 even in the event where the leading end 3a of the film 3 hits the take-up spool 11 before the center of the take-up spool 11 like shown in FIG. 8 when the back cover 6 is closed, the camera body 5 is provided with film hold-down means 20 operative to hold down the leading portion of the film 3 against the take-up spool 11 at a position in which closer to the film chamber 7 than a generating line of the take-up spool 4 closest to the back cover 2.

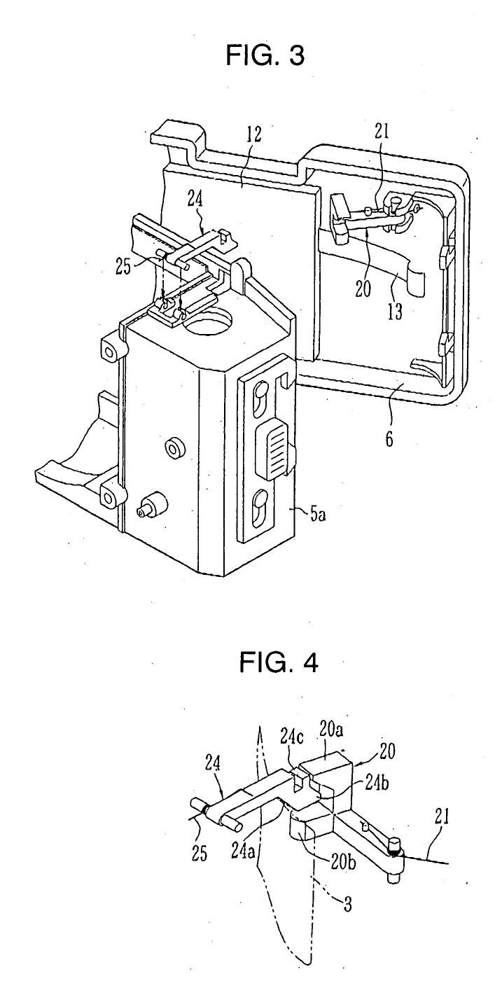

Referring to FIGS. 3 and 4, the film hold-down means 20 comprises a film hold-down lever 21 pivotally mounted to the back cover 6 and a film detection lever 24 pivotally mounted to a top wall 5b of the camera body 5a. Specifically, the film hold-down lever 21, that is made as a single integral piece, comprises a generally U-shaped head having an upper projection 21a and a lower projection 21b, a swing arm 21c mounted on a pivot shaft 22 secured to the back cover 6 and a biasing spring 23 mounted between the swing arm 21c and the pivot shaft 22 so as to force the film hold-down lever 21 toward the take-up spool 11 (in a counterclockwise direction as seen in FIG. 4). The upper projection 21a has an under surface inclining downward from a side close to the film winding chamber 9 toward the back cover 6. The lower projection 21b has a convex tip curving in a direction of advancing the film 3. On the other hand, the film detection lever 24 is mounted on a pivot shaft 25 secured to the top wall 5b of the camera body 5a and is forced downward by a biasing spring 26 mounted between the film detection lever 24 and the pivot shaft 25. The film detection lever 24 has a detection surface 24a inclining downward from a side close to the film winding chamber 9 toward a side of the back cover 6, a push projection 24b formed at a side opposite to the detection surface 24a so as to mate the under surface of the upper projection 21a of the film hold-down lever 21, namely incline upward from a side of the back cover 6 toward a side of the film winding chamber 9, and a stopper projection 24c extending upward right behind the push projection 24b. The film detection lever 24 extends partly within the film winding chamber 9 so as to put the detection surface 24a within the passageway of the film 3. When the back cover 6 is closed, the film hold-down lever 21 is brought into a position where its upper projection 21a fits the push projection 24b and the stopper projection 24c. In this condition, when the film detection lever 24 turns upward about the pivot shaft 25 against the biasing spring 26, it forces the film hold-down lever 21 backward, namely toward the back cover 6, about the pivot shaft 22 against the biasing spring 23 through engagement between the push projection 24b of the film detection lever 24 and the upper projection 21a of the film hold-down lever 21. Further, in the event where there is no film loaded in the camera 5 while the back cover 6 is closed, the film hold-down lever 21 is stopped by the film detection lever 24 in a position where the lower projection 21b remains apart from the take-up spool 11.

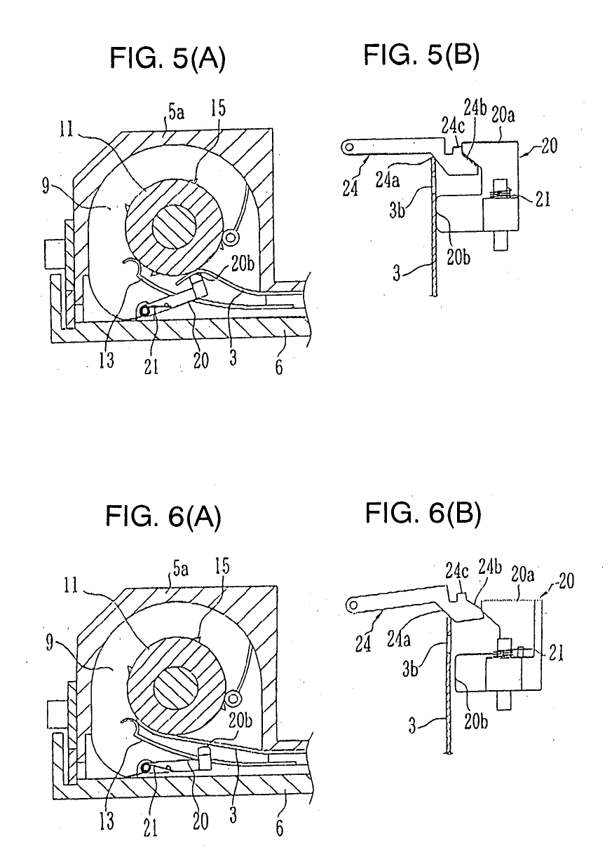

Operation of the film hold-down means 20 will be hereinafter described with reference to FIGS. 5A-5B and 6A-6B. First of all, the back cover 6 is closed after placing a film cartridge 10 with the film 3 partly pre-drawn out within the film chamber 10 and pulling the film 3 across the back of the camera body 5a. On the way of initially closing the back cover 6, if the film 3 partly pre-drawn out of the film cartridge 10 is too short to put its leading end 3a on the take-up spool 11 within the film winding chamber 9, the pressure leaf spring 13 fails to press down the film 3 against the take-up spool 11. In consequence, the film 3 is only allowed to lie in a position where its leading end 3a abuts against the take-up spool 11 like as shown in FIG. 8. On the way of further closing the back cover 6, the film hold-down lever 21 approaches toward the film 3 and then presses down the film 3 with the lower projection 21b thereof against the take-up spool 11 at a position before the ridge line of the take-up spool 4, namely a generating line of the take-up spool 4 closest to the back cover 2, as shown in FIG. 5A. In this instance, the lower projection 21b of the film hold-down lever 21 pushes a margin inside a row of perforations 3b of the film 3. As a result, as shown in FIG. 5(A), the film 3 at its leading portion rises up a little from the take-up spool 11 and curves convexly with respect to the take-up spool 11 so as thereby to be partially brought into contact with the take-up spool 11. When the camera 5 automatically actuates the drive motor in a normal direction to rotate the take-up spool 11 almost as soon as the back cover 6 is fully closed, at least one of the circumferential catching claws 15 of the take-up spool 11 rests assured of engagement with the perforations 3b of the film 3.

As shown in FIG. 5B, while the back cover 6 remains fully closed and locked, the film hold-down lever 21 is prevented from further swinging toward the take-up spool 11 through contact between its upper projection 21a of the film hold-down lever 21 and the stopper projection 24c of the film detection lever 24, so as thereby to keep the film 3 from being tightly nipped between the lower projection 21b of the film hold-down lever 21 and the take-up spool 11. In this instance, although the film detection lever 24 is essentially used to put its stopper projection 24c in interference with the upper projection 21a of the film hold-down lever 21 so as thereby to prevent the film hold-down lever 21 from bringing the lower projection 21b into direct contact with the take-up spool 11 in the absence of the film 3 in the camera body 5a, it may have an ancillary function of locating the film hold-down lever 21 in a given initial position in the event where the film 3 is pre-drawn out too short to reach a ridge line of the take-up spool 4.

As shown inn FIG. 6(A), when the camera 5 further rotates the take-up spool 11 after once the claws 15 of the take-up spool 11 have been brought into engagement with perforations 3b of the film 3, the film 3 at the leading end 3a enters a nip between the take-up spool 11 and the pressure leaf spring 13 and is bitten therebetween, so as thereby to be pressed against the take-up spool 11 by the pressure leaf spring 13. Concurrently, the film 3 is strained and, consequently moved backward. As a result, the film 3 at its upper edge exerts pressure on the detection surface 24a of the film detection lever 24, so as thereby to force the film detection lever 24 to swing upward about the pivot shaft 25 against the biasing spring 26. This swing motion of the film detection lever 24 brings its push projection 24b into engagement with the upper projection 21a of the film hold-down lever 21 and then forces the film hold-down lever 21 to swing about the pivot shaft 22 against the biasing spring 23 as shown in FIG. 6(B), resulting in that the film 3 is loose of the film hold-down lever 21.

A further rotation of the take-up spool 11 winds the film 3 around the take-up spool 11. When the photoelectric sensor 16 detects a predetermined number of perforations 3b of the film 3, the camera 5 automatically stops the drive motor to locate a first unexposed frame of the film 3 right behind the exposure aperture 8, completing initial preparation of the camera 5 for exposure.

Every time a shot is taken, the camera 5 automatically actuates the drive motor to rotate the take-up spool 11 to wind the film 3 thereon by one frame and then stops the drive motor, so as thereby to locate an unexposed frame of the film 3 right behind the exposure aperture 8, putting the camera 5 ready for another shot. When all frames of the film are exposed, the camera 5 automatically actuates the drive motor to rotate in the reverse direction to rotate the spool of the film cartridge 10 through the film rewind mechanism and keeps the drive motor actuated until the film 3 is fully rewound into the film cartridge 10.

In this instance, although the film hold-down lever 21 presses down the film 3 closely against the take-up spool 11 for buildup of engagement between the perforations 3b of the film 3 and the circumferential catching claws 15 of the take-up spool 11, it may be allowed to provide a gap between the film 3 and the take-up spool 11 as long as the gap is sufficiently small to build up the claw and perforation engagement while the take-up spool 11 rotates.

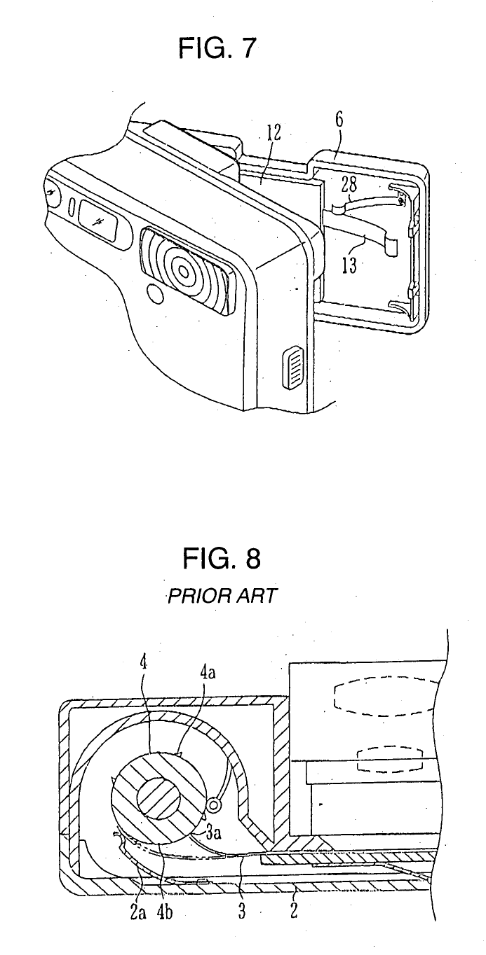

Referring to FIG. 7 showing another embodiment of the present invention, the camera 5 is provided with a film hold-down leaf spring 28 in place of the film hold-down means 20. The film hold-down leaf spring 28 presses the film 3 against the take-up spool 11 to hold down the film 3. As the take-up spool 11 winds the film 3 therearound, the film hold-down leaf spring 28 is forced backward, namely toward the back cover 6, by the film 3. This alternate embodiment is disadvantageous in terms of causing increased dynamic friction since the film hold-down leaf spring 28 remains contacted to the film 3 and, however, advantageous in view of a reduction in the number of parts and parts cost.

It is to be understood that although the present invention has been described with regard to a preferred embodiments thereof, various other embodiments and variants may occur to those skilled in the art, which are within the scope and spirit of the invention, and such other embodiments and variants are intended to be covered by the following claims.

1. A photographic camera that is loaded with a film cartridge with a film partly pre-drawn out by placing the film cartridge within a film chamber at one end of a camera body, pulling the film across the back of the camera until a leading end of the film is put on a cylindrical core of a take-up spool within a film winding chamber at another end of the camera body, and then automatically rotating the take-up spool to wind the film around the take-up spool and stopping the take-up spool when a first unexposed frame of the film is placed behind an exposure aperture of the camera body in response to closing a back cover of the camera, the photographic camera comprising:
film hold-down means disposed in a passageway of the film for holding down the film toward the take-up spool at a position before a generating line of the cylindrical core of the take-up spool closest to the back cover when the back cover is closed.

2. The photographic camera as defined in claim 1, wherein said cylindrical core is provided with circumferential claws extending from a periphery of the cylindrical core of the take-up spool so as to engage with perforations of the film.

3. The photographic camera as defined in claim 2, wherein said film hold-down means comprises a film hold-down lever pivotally mounted to the back cover and urged toward the take-up spool so as to hold down the film toward the take-up spool and a film detection lever mounted to the camera body so as to detect the film with said perforations in engagement with said circumferential claw, wherein said film detection lever keeps said film hold-down lever from holding down the film when detecting the film being wound around the cylindrical core of the take-up spool.
